(19) United States
(12) Patent Application Publication
(10) Pub. No.: US 2010/0093880 A1
(43) Pub. Date: Apr. 15, 2010

(54) RECYCLING CLEAVAGE OF POLYURETHANES

(76) Inventors: Manfred Bergfeld, Erienbach-Mechenhard (DE); Andreas Kieffer, Koln (DE)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/375,819

(22) PCT Filed: Mar. 19, 2007
(86) PCT No.: PCT/US07/06786

§ 371 Date: Jan. 30, 2009

Related U.S. Application Data
(60) Provisional application No. 60/871,118, filed on Dec. 20, 2006.

(51) Int. Cl. C08J 11/04

(52) U.S. Cl. 521/49.5

(57) ABSTRACT

A process is described for splitting polyurethanes and polyurethaneureas, in which the polymer is first reacted with gaseous or liquid secondary aliphatic or cycloaliphatic amines, the secondary urea formed, after removal with hydrogen chloride, is split to the isocyanate, and the polyols or polyamines also formed in the reaction are worked up and purified. It is possible by the process according to the invention to work up polyurethanes, polyurethaneureas, etc., of any origin, and to break them down into the starting materials, specifically the isocyanates, polyols or polyamines, to form starting materials in very high quality, which can be reused for the synthesis of any polyurethanes or polyureas. The invention further provides for the preparation of secondary bis-ureas from polyurethanes or polyurethaneureas or/and ureas.

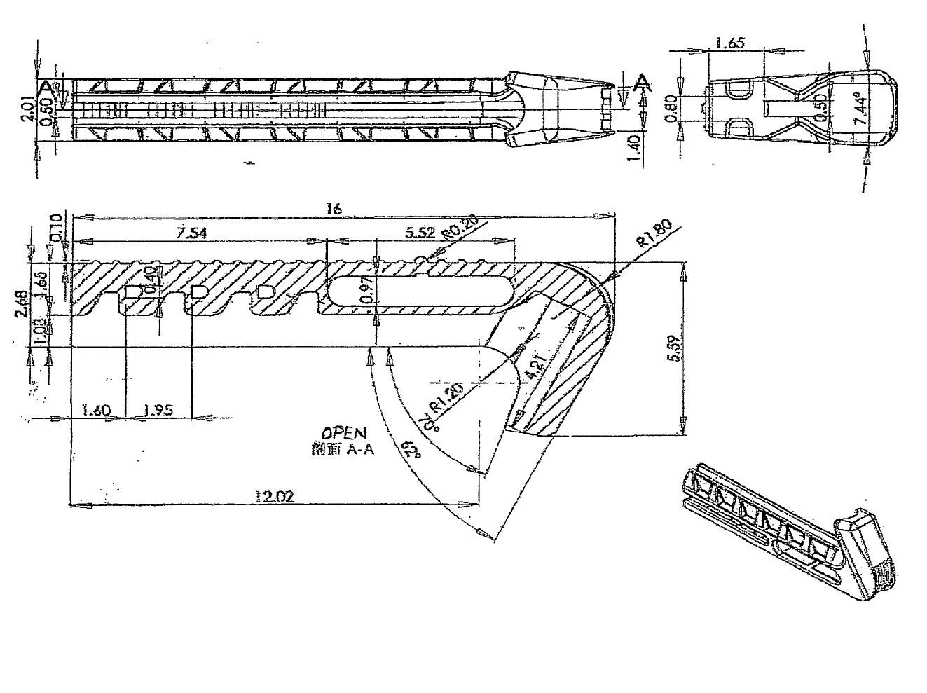

This application is a US national phase application of PCT/US2007/006786, filed Aug. 1, 2007, which claims priority to German Patent Application No. 10 2006 036 007.9, filed Aug. 2, 2006. The entire contents of both are hereby incorporated by reference.

The invention relates to a technique of recycling polyurethanes that can contain additional structures, as the case may be, such as urea, urethdion, isocyanurate- and the like, alongside the actual urethane structures —NH—CO—O—.

Such structural elements are elucidated in the following formulae:

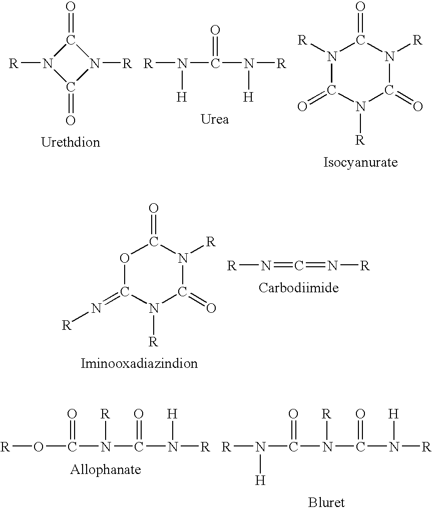

The definition of cleavage or splitting, for the purpose of this invention, is understood as the recycling of polyurethanes and polyurethane ureas, be it for the purpose of elimination, disposal, or refurbishment of such polymers in the form of waste or by-products as they arise during their manufacture or the recycling of every day articles, or parts thereof, which consist of, or contain, such polyurethanes, polyurethane ureas, and the like. The goal of the recycling, for the purpose of the invention, is to chemically depolymerise the polymers and in particular, to acquire the starting materials from which these are manufactured.

Here we will name, above all:
1. Di- and Polyisocyanate
2. Macropolyols, in particular, macrodiols such as polyether, polyester as well as polycaprolactone, and polycarbonate.
3. Chain extenders and/or cross-linkers

In relation to the latter we must particularly mention the lower molecular glycols and diamines.

Polyurethanes are chemical products that, as repetitive units, have urethane groups, i.e. NH—CO—O units, as well as, as the case may be, urea groups —NH—CO—NH—, and contain similar units as explained above. In general they are obtained by addition-reaction from alcohols of twofold or higher valency or amines, and isocyanates according to the following chemical equations:

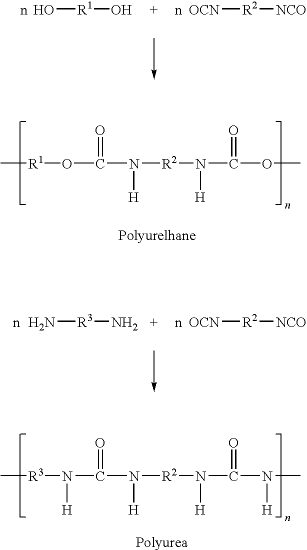

R1, R2, and R3 represent lower molecular polymer groups or even higher molecular and polymer groups that may also contain urethane groups.

In addition to the above-mentioned examples displaying primarily linear polyurethanes, there may also be polyurethanes having branched or networked structures as well.

The characteristics of the manufactured polyurethanes are strongly influenced by the type of the isocyanate, chain extender, and macrodiols as well as by the molecular ratio of the isocyanate to the chain extender and the macrodiole.

Polyurethanes can therefore be custom-made for all areas of application and as a result have found entry into countless areas of application.

### Examples of Multi-Functional Isocyanates:

1,3-bis(1-isocyanato-1-methylethyl)benzene (m-TMXDI)
1,6-diisocyanato-2,2,4-trimethyl hexane
1,6-diisocyanato-2,4,4-trimethyl hexane
1,4-diisocyanatocycolohexane (trans-CHDI)
1,3-bis(isocyanatomethyl)cyclohexane (H6,XDI)
hexamethylene diisocyanate (HDI)
3-isocyanatomethyl-3,5,5-trimethyl cyclohexyl isocyanate
(IPDI)
1,3-bis(isocyanatomethyl) benzene (XDI)
bis(isocyanatomethyl)-bicyclo [2.2.1] heptane, (NBDI)
(2,5-NBDI) (2,6-NBDI)
2-heptyl-3,4-bis(9-isocyantononyl)-1-pentyl-cyclohexane
(DDI)
toluene diisocyanate(TDI) (2,4-TDI) (2,6-TDI)
methylenediphenyldiisocyanate (MDI) (4,4-MDI) (2,4-MDI)
(2,2-MDI)
polymeric MDI (PMDI)
1,5-Naphthalene diisocyanate (NDI)
p-phenylene diisocyanate (PPDI)
3,3-dimethylbiphenyl-4,4-diisocyanate (TODI)

Multi-functional isocyanates may be introduced as products of addition-reactions, and may be, for example, developed through the addition of polyols to one of the above specified isocyanates:

Chemical Equation of the Pre-Polymer Formation:

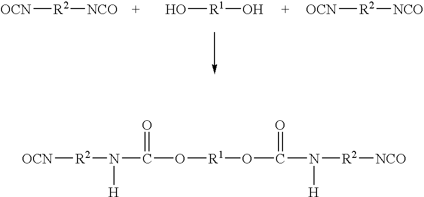

Generally, macrodiols are applied with a molecular mass between Mn=500-20000:

Preferred macrodiols are: polyester, polyether, polycarbonate, and hydrocarbon polyols.

### 1. Polyester Polyols:

These are obtained by reacting polyols with polycarboxylic acids or their derivatives.

The following are named as examples of polyols: ethyleneglycol, 1,2-propanediol, 1,3-propanediol, 1,3-butanediol, 1,4-butanediol, 1,6 hexanediol, 2,2-bis-[hydroxmethyl]-1-butanol, 2,2 dimethyl-1,3-propanediol, bis-[2-hydroxy-ethyl]-ether, glycerine, mono- and disaccharides, trimethylpropane, polyethyleneglycole, polypropyleneglycols.

As dicarboxylic acids, or anhydrides, that can be used for the construction of the polyesters, the following examples are named:

Succinic acid, bicyclo[2.2.1]heptene-5,6-dicarboxylic acid anhydride (HET-acid anhydride), adipic acid, phthalic acid anhydride, isophtalic acid, terephtalic acid, 1-2-cyclohexane dicarboxylic acid, 1,4-cyclohexane dicarboxylic acid.

Special polyester diols are also polycaprolactones.

### 2. Polycarbonates:

Polycarbonates are, for the purposes of the invention, among other things, reaction products from carbonic acid diethyl ester (diethyl carbonate), and diphenyl ester or phosgenes respectively with the above-mentioned glycols.

### 3. Polyethers:

Among them there are compounds like polyethyleneglycoles, polypropyleneglycoles and polytetrahydrofuraneglycoles.

### 4. Hydrocarbon Polyols:

To these belong among others, poly(1,3 butene), poly(isoprene), poly(vinylchloride), polyisobutylene) and other polyolefines with respectively terminating OH-Groups.

Polyols may be introduced as products from addition-reactions, which, through the addition of multi-functional alcohol to, for example, one of the above-mentioned isocyanates or isocyanate pre-polymers, result in:

Chemical Equation Macrodiol Formation:

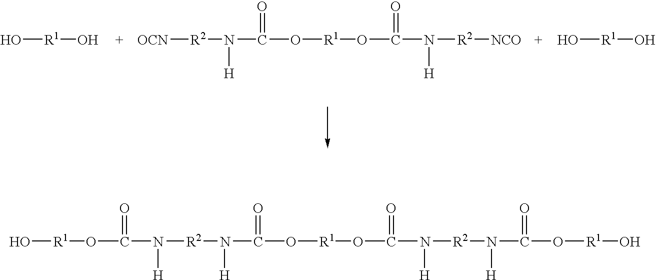

Chain Extenders and/or Cross-Linkers:

As chain extenders and cross-linkers mostly short chain di- and/or multi-functional alcohols or amines are applied. In the manufacture of cell elastomeres water is often applied as a chain extender, the water initially reacting with isocyanate groups, producing the corresponding amines, and subsequently reacting with isocyanate, resulting in a urea grouping.

The reaction with water takes place according to the following chemical equation:

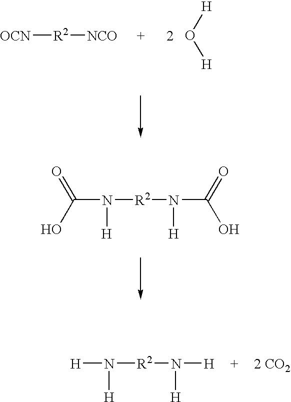

The resulting diamine continues to react in a consecutive reaction to a polyurethane-urea-compound:

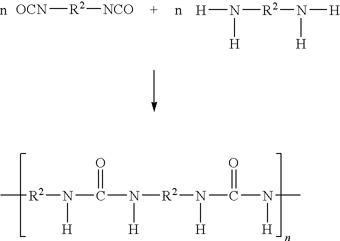

As amines, applied as chain extenders, the following compounds are named as examples:
bis-[4-amino-3-chloro-phenyl]methane (HOCA)
4-chloro-3,5-diamino-benzoic acid-(2-methyl-propylester)
4 amino-benzoic acid-ester of glycoles
bis-[2-amino-benzoyloxy]-compounds
1,2 bis-[2-amino-phenyl thio]-ethane
1,3 bis-[4-amino-benzoyloxy]-propane
bis-[4-amino-3-methyoxycarbonyl-phenyl]-methane
2,5-diamino-1,3-dichloro-benzene
bis-[2-amino-phenyl]-disulfan
3,5-diamino-4-methyl-benzoic acid-alkyle ester
2,4-diamino-benzoic acid-ester (or amide)
2,5-diamino-benzonitril
oligo ethylene glycol-bis-4-aminobenzoate
(4-chlorine-3,5-diamino-phenyl)-acetic acid-ester
terephthalic acid-bis-[2-(2-amino phenylthio)-ethyl ester]
4-tert.-butyl-3,5-diamino-benzoic-acid-ester
4-tert.-butyl-3,5-diamino-benzonitrile
4-chloro-3,5-diamino-toluene
2,4-diamino-4-methyl-benzene-sulfonic acid-dibutylamide
4,4-methylene-bis(3 chloro 2,6-diethylaniline) (MCDEA)
diethylentriamine (DETA)
1,6-hexamethylene diamine

The main field of application for such polyurethanes and polyurethane-ureas are: rigid and soft foams, cell elastomers, coatings, lacquers, adhesives, binders, sealing compounds, elastomers, thermoplastics, casting resins, and so forth.

In this form polyurethanes have found entry in nearly all industrial areas of application such as automotive, naval, construction, mining, etc.

With increasing production and usage of this type of polyaddition-polymers the task of disposing of, or recycling, these polymers after use increasingly presents itself. Naturally, the same goes for waste products that occur during the manufacturing of these polyurethane compounds.

Up until now attempts to reprocess and recycle these types of products have not been lacking. Concerning processes that aim at the recycling of polyurethanes, and at least in part, the acquisition of some of the educts, hydrolysis and glycolysis are the major aspects. However, in theses processes only educts containing hydroxyl groups are recaptured. Furthermore these processes are very complicated and do not allow for the recycling of the high-priced isocyanates, because these are decomposed resulting in amines.

An additional possibility to recycle polyurethanes exists in that one shreds the polyurethanes into small pieces and adds the educts, such as isocyanates and polyols, and continues to process this mixture under polyaddition conditions as is done in a die casting procedure, for example. Of course, in doing so, a cleavage of the reused materials among the educts does not take place, and it goes without saying, that the products that are manufactured according to such a process are inferior with respect to their material characteristics.

The patent literature and also the scientific literature concerning these types of recycling processes are very extensive. For example, a process for the reconditioning of a polyurethane hard foam is described in the EP 1 149 862 B1.

It concerns a process for manufacturing a starting material for polyurethane hard foam production, including the steps:
shred the polyurethane hard foam that covers a discharged refrigerator in order to remove a lump of the polyurethane hard foam;
crush the polyurethane hard foam lump into a powder;
liquefy the powder made from the polyurethane hard foam using an aminolysis reaction or a glycolysis reaction;
remove pieces of contaminants from the liquified polyurethane hard foam powder via filtration; and
convert the liquified polyurethane hard foam powder with either hypercritical or hypocritical water, in order to decompose the polyurethane hard foam powder.

This process is very laborious and does not deliver any starting materials, i.e. educts; in particular it does not yield the initially applied isocyanate, whereby any polyurethane with good characteristics might again be manufactured. Therefore the recycled material is only applicable for the manufacturing of products that more or less, are identical to the disposed materials.

The U.S. Pat. No. 5,891,927 from Apr. 6, 1999 also describes a process for the recycling of polyurethanes, in particular from microcellular polyurethane, that also specifies that one shreds the polyurethane and adds to the shred polyurethane the starting materials, i.e. polyol and polyisocyanate, carries out the respective reaction and finally obtains a recycled product, that is more or less similar to the educts, that have been recycled, but is inferior in respect to its properties.

In the US-patent application US 2002/0010222 A1 a method for the processing of polyurethane refuse is described which consists of the execution of a chemolysis in order to extract polyol products and after that to use these polyol products as initiators in a reaction with alkylene oxide in order to extract oxy-alkylated polyol for the production of polyurethanes. Also this reaction is only suitable for a very limited range of application.

In the US 2003/0009007 A1 a process for the splitting of polyurethanes is described whereby a mixture of a solvent, water, and one or more polyurethanes is heated to a temperature of at least 180° C. under a pressure of at least 4 bar. Recycling of the diisocyanates used in the manufacture of said polyurethanes is not possible according to this document, because it is hydrolyzed into an amide. Even in this relatively recent application the work-up with regards to the technique is described as using, above all, glycolysis or hydrolysis.

Even though numerous processes for the recycling and work-up of polyaddition-polymers, in particular of polyurethanes and polyurethane ureas and so forth, are well-known, a great need for improved processes still exists, in particular in order to recycle the valuable isocyanate, something that until now had not been achieved.

The object of the invention is therefore to provide a process for the recycling of polyurethanes, polyurethane ureas, and the like, whereby the starting materials, namely the di- or polyisocyanates, the glycols, the polyglycols and the diamines as such, can be reclaimed and can consequently be available for a new synthesis of polyurethanes of polyureas.

Furthermore, object of the invention is to provide a process, whereby the recycled starting materials are provided with a high quality and are available in a high quality for the synthesis of any polyurethane, polyurethane ureas or other isocyanate addition products, that are not identical with the initial polyaddition polymers that were recycled.

Moreover, it is the object of the invention to provide a process whereby the polyaddition polymers of vastly differing provenance can be recycled and thereby make possible an almost quantitative recovery of the starting substances of the initial polyisocyanates, hydroxyl-containing and amine-containing compounds.

The object is solved with a process of cleavage of polyurethanes, polyurethane ureas and the like, that is characterized in that one:
a) converts these polymers with secondary aliphatic or secondary cycloaliphatic amines, wherein secondary bis-ureas and hydroxyl-groups-containing diols or polyols and, as the case may be, amino-group-containing compounds result,
b) separates the secondary bis-ureas from the hydroxyl- or amino-group-containing compounds,
c) cleaves the separated secondary bis-ureas with hydrogen chloride to obtain the starting isocyanate and,
d) separates the resulting isocyanate from the simultaneously produced HCL-Salt of the secondary amines and carries out the work-up of both products separately, and
g) separately recycles and purifies the hydroxyl-groups- or amino-groups-containing compounds resulting from the treatment with the secondary aliphatic or cyclo-aliphatic amine compounds.

Preferably, the reaction with the secondary amine is carried out within an inert solvent.

Solvents particularly suited for this are: Ether, ester, and aliphatic, cyclo-aliphatic and aromatic hydrocarbons, as well as chlorinated aliphatic and aromatic hydrocarbons.

From the group of ethers the following examples are specified: Methyl-t-butyl ether, dibutyl ether, ethylene glycol dimethyl ether, tetrahydrofuran and dioxane.

From the group of esters the following examples are specified: methyl formate, acetic ester, and butyl ester.

From the group of hydrocarbons the following examples are specified: Ligroin, petroleum ether, cyclohexane, methylcyclohexane, toluene, xylene, benzene.

From the group of chlorinated hydrocarbons the following examples are specified: methylene chloride, chloroform, carbon tetrachloride, chlorobenzene, 1,2 dichlorobenzene, methyl chloroform, perchlor tetraethylene. As further solvents the following examples are also specified: acetonitrile, benzonitrile, nitromethane and nitrobenzene.

Solvents, in which the produced urea is insoluble, and thereby easily separated from the diol components, have proven particularly advantageous.

These solvents can be chosen by an artisan in the course of few pre-experiments and can, of course, vary according to the treated polyurethanes and produced bis-ureas.

In a further embodiment of the process according to the invention the secondary aliphatic or cycloaliphatic amine is used in quantities so that it simultaneously functions as reactant and as solvent.

It goes without saying that in such a case in addition to the required stoichiometric content a sufficient excess is present so that the amine still exists in adequate quantities during the entire reaction so that it can function as a solvent. In doing so, it can be necessary to set the corresponding pressure in order to keep the amine in the liquid phase.

As a secondary amine compounds according to the formula VI are preferably used.

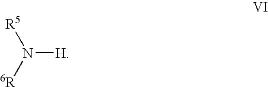

wherein R⁵ and R⁶ may be same or different and preferably denote —CH₃, —C₂H₅ or —C₆H₁₁. In principle higher and branched alkyl groups may also be used.

In a particularly advantageous embodiment of the process according to the invention the resulting secondary urea is separated from the reactant mixture, cleaned and obtained as a separate, intermediate product.

The reaction of polyurethane or respectively polyurethane ureas with the secondary amine takes place at elevated temperatures, e.g. at 80 to 250 degrees Celsius, preferably between 80° C. and 180° C., and in particular at 100° C. to 150° C. At temperatures lower than 80° C. the cleaving-reaction occurs in most cases very slowly and can be so slowly, that a commercial realization of the process is barely possible, the process coming to a standstill, or doesn't even start.

The cleavability is extremely dependent on the reactivity of the polyurethane groups, e.g. aromatic polyurethanes are more reactive than aliphatic ones and least reactive are sterically inhibited ones.

It lies within the scope of the general technical know-how of the average expert to establish suitable temperatures i.e. lower boundary of temperature in the course of a few experiments.

Then again, the risk may occur, that within macromolecular polyols like polyester-polyol, the so-called soft segments of a polyurethane, may be prone to cleavage, due to excessively high temperatures, in particular at temperatures of above 180 degrees Celsius, and may lead to amide formation.

A corresponding reaction mechanism is portrayed in the following starting with an exemplary polybutylene adipate.

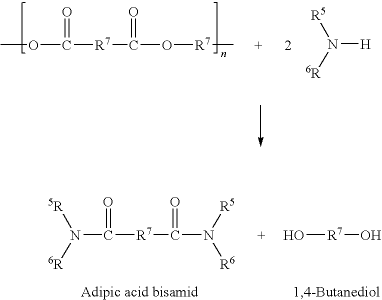

wherein R⁷=—CH₂—CH₂—CH₂—CH₂—-Concerning the expert, the above-said applies for the upper temperature boundary; a few experiments are sufficient in order to rule out temperatures that are too high. On reacting the polyurethane with the secondary amine, a reaction takes place that can be depicted by the following chemical equation.

### Step 1

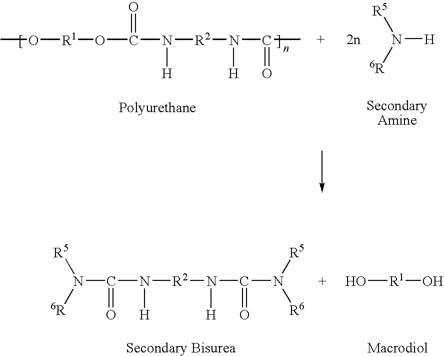

The secondary urea produced in step 1 and separated from the reaction mixture is reacted with hydrogen chloride to provide the initial isocyanates, wherein the secondary amine precipitates as a hydrochloride.

Preferably gaseous hydrogen chloride is to be used.

It is also advantageous to utilize dried hydrogen chloride, meaning, in particular, free of water.

This amine-HCl salt can be converted back to the secondary amine through a reaction with an alkaline compound such as sodium hydroxide, so that the secondary amine used for cleavage can be fully reclaimed and re-used.

The treatment of the secondary urea, that is, its reaction with hydrogen chloride, can be represented by the following chemical equation.

### Step 2

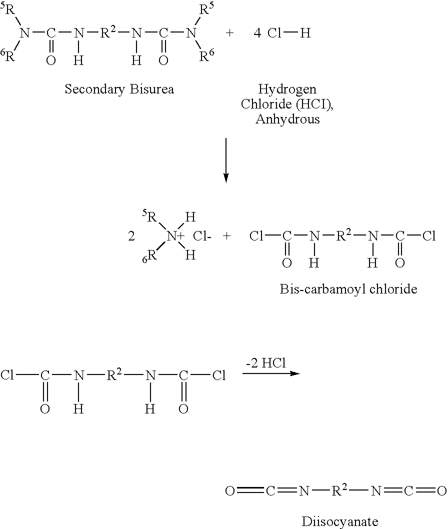

The salt produced from the secondary amine and the hydrogen chloride can be reclaimed according to the following chemical equation.

### Step 3

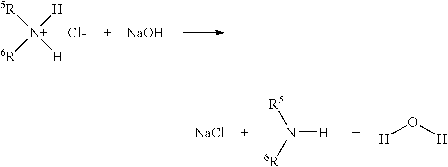

If, for example, dimethyl- or diethylamine is used, such can be reclaimed by distillation from the basic aqueous solution. Using higher, secondary amines, a separation process is preferred, wherein for example an extraction is carried out.

From the previous equation above it follows that the procedure according to the invention for cleaving polyurethane, the cleavage can be carried out in such a manner that all starting chemicals, namely the compounds containing hydroxyl groups as well as chain extenders and isocyanates, can be reclaimed and only sodium chloride is produced as a by-product.

The aforesaid applies analogously to the cleavage of polyurethane ureas.

The above described method for cleaving and reclaiming the polymers in question can be carried out with practically any matter, be it faulty batches of educts that cannot be used for the production of valuable end products, be it waste or by-products produced in the manufacturing and shaping of the polymers, for example in machining or in pressing of semi-finished parts, or be it resin residues from moulding or casting. That is, practically all forms of the mentioned polyurethanes can be recycled.

It was particularly surprising that the method according to the invention makes it possible to decompose polyurethanes and polyurethane ureas and the like quantitatively into the starting materials, that is, the di- or polyisocyanates used in the synthesis and the compounds containing hydroxyl groups such as glycols, polyglycols, compounds comprising terminating hydroxyl groups in polyesters and polyethers or the employed compounds containing amine groups (chain extenders).

This applies in particular to the di- and polyisocyanates, which have not been possible to reclaim as such in known recycling methods.

It was further surprising that this method allows the use of all kinds of polyurethanes and polyurethane ureas, be they linear, branched or networked polymers. The quality of the reclaimed materials is excellent and is equal to the starting materials used; that is they can be used in initial quality again in the synthesis of various different kinds of polyaddition-polymers.

Thus the reclaimed starting materials are also re-usable for practically any purpose, and it is possible to produce polyaddition polymers such as polyurethane and polyureas from the reclaimed starting materials which are completely different from the products recycled.

It was also surprising that, according to the invention, the reclaimed materials can be used for the synthesis of products that are equal or better in terms of their properties than the recycled products.

It was also in particular surprising that the starting materials can be reclaimed in such good quality that they can be sold elsewhere for uses that have nothing in common with polyaddition polymers.

The invention will be further illustrated by the following examples:

### EXAMPLE 1

Recycling a PPDI-based PU moulding waste

a) Cleavage of PU granules with diethylamine 400 g PU granulate, produced from 63.12 g 1,4-phenylene diisocyanate, 315.69 g adipic acid ethylene glycol polyester (molecular weight=2000), 19.59 g 1,4-butanediol and 1.58 g of other different additives, were granulated to 4 mm grain size.

The polyurethane pellets obtained in this manner are placed, with 600 g diethylamine and 1800 g 1,2-dichlorbenzene, in a 5 litre steel autoclave with vision panel, turbine agitator, manometer and temperature display. The reactor content is heated to 60° C., then the reactor is closed and the temperature is continuously raised until, after about 2 hours, it reaches 140° C. At the same time, the pressure within the reactor reaches approximately 5.5 bar. As a result of this the polyurethane, stirred carefully, slowly dissolves. At the end of the reaction (about B hours) the agitator is stopped. The result is a clear yellow solution, in which a white to yellow precipitate has formed.

After cooling, the reagent mixture is filtered and the filtration residue is washed, in portions, with chloroform, in order to remove the adherent diethylamine. The washed and vacuum-dried deposit consists of 111.15 g (rate of yield 92%) 1,4-phenylene-bis-diethylurea.

b) Reclaiming the isocyanate PPDI by cleaving the bis-urea with HCl gas (atmospheric) 30.7 g PPD diethylurea obtained according to 1a is placed with 350 ml chlorobenzene in a 1 litre-3-necked flask while stirring. The mixture is freed from oxygen by introduction of oxygen-free nitrogen under normal pressure and at room temperature and then, in a preheated oil bath of 125° C., heated to 110° C. internal temperature within 10 minutes, whereby the PPD urea partially dissolves. Next the HCl gas is introduced for 5 minutes into the vigorously stirred mixture by means of a ground capillary at an internal temperature of 110° C., whereby after 1 minute already a clear light brown solution is produced. Following the completion of the HCl-induced cleavage the excess hydrogen chloride is removed using nitrogen at 110° C. inner temperature, whereby already after the first minute of stripping colourless Et₂NH HCl crystal flakes are precipitated. The slurry is then cooled to room temperature with an ice bath. The reaction mixture is then freed from chlorobenzene through application of vacuum, and the solid crystal slurry is dried at 40° C./1 Torr. Now the PPDI is extracted from the crystal deposit slurry with dry octane, while the Et₂NH HCl remains. After the octane is removed by distillation, 15.35 g PPDI is obtained (95.8% of theoretical yield).

c) Reclaiming the Diethylamine

The diethylamine-hydrochloride residue obtained in the filtration process is dissolved in excess aqueous sodium hydroxide solution and the released diethylamine is distilled off at normal pressure.

d) Reclaiming of soft segment and chain extender from the remaining solution the excess diethylamine is removed by fractionated distillation at atmospheric pressure, and subsequently the dichlorbenzene likewise, but in vacuum. 330.15 g brown oily liquid remains. From this, 19.05 g butanediol was distilled off in high vacuum. What remains is 311.10 g adipic acid ethylene glycol.

### EXAMPLE 2

Recycling of PU foams made from an isocyanate mixture:

a) 400 g polyurethane foam produced from 32.61 g 1,4-phenylene diisocyanate and 42.68 g 1,5-NDI as well as 301.69 g adipic acid ethylene glycol polyester (average molecular weight(MG)=2000), 21.36 g 1,4 butanediol and 1.50 g common additives is granulated to particle size of about 6 mm.

The polyurethane granulate thus obtained is placed with 600 g diethylamine and 1800 g 1,2 dichlorbenzene in a 3 litre steel autoclave with vision panel, turbine agitator, manometer, and temperature display. The contents of the reactor are heated to approximately 60° C., after which the temperature is continually increased until, after about 2 hours, it reaches 135° C. At the same time, the pressure within the reactor reaches approximately 5.5 bar. As a result of this the polyurethane slowly dissolves. By the end of the reaction (about 8 hours) a clear yellow solution is produced, containing a light yellow precipitate.

After cooling, the reagent mixture is filtered and, in portions, washed with chloroform. The washed and dried precipitate consists of 166.94 g 1,4-phenylene-bis-diethylurea and 1,5 naphthalene-bis-diethyl urea.

b) PPDI/NDI from urea splitting a mixture of 30.7 g PPD-diethyl urea and 44 g NDI-diethyl urea from step 2a is placed, with 700 ml chlorobenzene in, a 2 litre 3-necked flask while stirring, and, in an analogous manner as described in 1b, split with dry excess hydrogen chloride. After separating the diethylamine hydrochloride, the raw product is boiled down and concentrated at atmospheric pressure and then quantitatively transferred into a 250 ml round bottom flask and the chlorobenzene is distilled off in a vacuum, whereby the NDI and PPDI remain on the bottom in the form of yellow-brown crystals.

From the crystalline PPDI/NDI mixture, the PPDI is obtained fractionated distillation via a heated packed column at 101° C./0.05 bar (15.35 g=95.8% of theoretical yield). 26.45 g NDI (97.8% of theoretical yield) remains on the bottom, which can be further cleaned through recrystallization with octane.

c) Reclaiming the dialkylamine, soft segment, and chain extender.

The diethylamine and dichlorobenzene is distilled off in vacuum from the remaining solution. A 286.59 g (yield 95%) brown oily phase and a 18.26 g (yield 89.1%) lighter, clear phase are left over, which can be separated using a separating funnel.

IR spectroscopic examination shows the lighter phase to be 1.4 butanediol, the heavier phase being polyester polyol.

### EXAMPLE 3

a) Splitting of NDI polyurethane with secondary amine without use of additional solvent 400 g polyurethane granules produced from 82.7 g 1,5-naphthalene-diisocyanate, 295.35 g adipic acid ethylene glycol polyester (MG=2000), 20.46 g 1,4 butanediol and 1.47 different additives is granulated to particle size of about 4 mm. The polyurethane granulate thus obtained is placed, with 1800 g diethylamine, in a 5 litre steel autoclave with view panel, turbine agitator, manometer, and temperature display. The contents of the reactor are heated to approximately 60° C., after which the temperature is continually increased until, after about 3.5 hours, it reaches 130° C. At the same time, the pressure within the reactor reaches approximately 15 bar. As a result of this the polyurethane slowly dissolves. By the end of the reaction (ca 8 hours) a clear yellow solution is produced, containing a light-yellow precipitate. After cooling, the reagent mixture is filtered and, in portions, washed with diethylamine.

The washed and vacuum dried precipitate consists of 134.69 g (yield 96%) 1.5 naphthalene-bis-diethyl urea.

b) Reclaiming the 1.5 NDI through cleavage of the urea from 3a) with HCl gas 350 ml nitrobenzene is placed in a 1 litre enamel autoclave provided with distillation attachment, agitator, flow breaker, thermocouple, and gas-injection pipe, and then 134 g of the tetraalkyl urea from 3a are suspended by stirring vigorously. Then the contents of the reactor are heated to approximately 80° C., and under weak vacuum ca 30 ml nitrobenzene is distilled off in order to remove all traces of moisture. When this has been satisfactorily accomplished, the autoclave is closed and the contents are saturated with HCl gas at 1.5-2 bar. Subsequently the temperature is raised to 150° C. and kept thereat for 2 hours. As a result of this the initially thick and milky-white suspension very quickly thins and is transformed after about 30 minutes into a pale yellow solution. After this has been left overnight to cool at room temperature, the diethylamine hydrochloride has precipitated in the form of large flakes, which are then filtered off and, in portions, washed with petroleum ether. From the clear, pale brownish filtrate the nitrobenzene is extracted in high vacuum, and there remains, as residue, 80.2 g 1,5 NDI, which can be further cleansed with octane.

c) The diethylamine is reclaimed from the filtered diethylamine hydrochloride in a manner analogous to Example 1.

d) The diethylamine is distilled off in vacuum from the remaining solution resulting from cleavage according to 3a. A 280.59 g (yield 95%) brown oily phase and a 18.26 g (yield 91%) lighter, clear phase are left over, which can be separated using a separating funnel.

IR spectroscopic examination reveals the lighter phase to be 1,4 butanediol, the heavier phase to be polyester polyol.

### EXAMPLE 4

Recycling of a PU Casting-Resin on the Basis of a MDI/TDI Polyurethane Mixture

a) Polyurethane cleaving with dimethylamine 329.38 g polyurethane granulate produced from 60 g MDI, 34.97 g TDI, 200 g adipic acid ethylene glycol polyester (MG=2000), 33.85 g 1,4 butanediol and 1.1 g various additives are reduced to a granulate of ca 4 mm particle size.

The polyurethane granulate obtained in this way is cleaved with 400 g dimethylamine and 1300 g 1,2 dichlorbenzene as in example 1a, but at 135° C., whereby the pressure, on account of the low boiling point of the dimethylamine, rises up to 20 bar.

Cooling the reaction mixture, filtering and washing in portions with 250 ml water follows analogously the description in EXAMPLE 1a. Altogether 130.6 g tetramethyl urea mixture of TDI and MDI is obtained.

b) Cleaving the urea mixture

The mixture is split in a manner analogous to Example 1b, in a glass autoclave with excess hydrogen chloride, at 110° C. After separating the dimethylamine hydrochloride, first the solvent (dichlorobenzene) is removed from the remaining solution by distillation, and then the two isocyanates TDI and MDI are separated by fractionated distillation in high vacuum. In this way 58 g pure MDI and 32.5 g pure TDI were reclaimed.

c) Next the dimethylamine and water are removed by distillation at normal pressure, and in a manner analogous to the above given examples, the soft segment and the chain extender butanediol were reclaimed.

### EXAMPLE 5

Cleavage of polyurethane on the basis of NDI/isosorbide and polyesterpolyol 400 g polyurethane granulate, produced from a polyurethane on the basis of 80.14 g 1,5 naphthalene-diisocyanate, 286.22 g adipic acid ethylene glycol polyester (MG=2000), 32.1 g D-isosorbide and 1.43 g common additives is reduced to granulate form of 4 mm grain size. The obtained polyurethane granulate is reacted and processed with 600 g diethylamine and 1800 g dichlorbenzene in a 3 litre steel autoclave in a manner analogously to example 4.

The washed and dried precipitate consists of 123.7 g (yield 91%) 1.5 naphthalene-bis-diethyl urea. This, in a manner analogous to example 3b, can be transformed into 1,5 naphthalene-diisocyanate (78 g) of high quality.

The diethylamine and the remaining 1,2 dichlorbenzene is distilled off in vacuum from the remaining solution. A 301.21 g brown oily liquid is left over, from which 29.3 g isosorbide and 271.91 g polyester polyol are reclaimed.

1. A recycling method by cleaving of polyurethanes as well as polyurethane ureas, characterized in that one:
a) reacts said polymers with secondary aliphatic or secondary cycloaliphatic amines, whereby secondary bis-ureas and diols or polyols having hydroxyl-groups and compounds having amino-groups result,
b) separates the secondary bis-ureas from the compounds having hydroxyl- or amino-groups,
c) cleaves the separated secondary bis-ureas with hydrogen chloride, providing the initial isocyanates, and
d) separates the produced isocyanates from the simultaneously produced HCl-salt of the secondary amines and subsequently processes both products separately,
g) separately processes and cleans the compounds having hydroxyl- or amino-groups, that were produced in the treatment with the secondary aliphatic or cycloaliphatic amines.

2. A method according to claim 1, characterized in that gaseous hydrogen chloride is used.

3. A method according to claim 1, characterized in that dry, in particular anhydrous hydrogen chloride is used.

4. A method according to claim 1, characterized in that the reaction with the secondary amine is carried out in an inert solvent.

5. A method according to claim 4, characterized in that as an inert solvent one solvent of the group consisting of ether, ester, aliphatic, cycloaliphatic, aromatic hydrocarbon or chlorinated hydrocarbon, is used.

6. A method according to claim 1, characterized in that a solvent is used in which the produced bis-urea is insoluble.

7. A method according to claim 1, characterized in that the secondary amine used for the re-division of the polyurethane or polyurea functions simultaneously as solvent and reactant.

8. A method according to claim 1, characterized in that that, as a secondary amine, a compound is used according to the formula VI 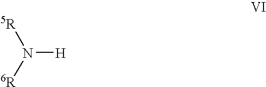
wherein R⁵ and R⁶ denote a same or different substituent selected from the group consisting of —CH₆, —C₂H₅ or C₆H₁₁.

9. A method according to claim 1, characterized in that the reaction is carried out in a temperature range between 80° C. and 250° C.

10. A method according to claim 9, characterized in that the reaction is carried out in a temperature range between 100° C. and 150° C.

11. A method for producing secondary ureas, characterized in that a secondary urea produced as by-product with the technique according to claim 1 is cleaned and isolated as an independent product.
